(19) United States
(12) Patent Application Publication
(10) Pub. No.: US 2023/0268118 A1
(43) Pub. Date: Aug. 24, 2023

(54) METHOD OF MANUFACTURING A PERMANENT MAGNET

(71) Applicant: EOS of North America, Inc., Novi, MI (US)

(72) Inventor: Richard B. Booth, Bluffton, TX (US)

(73) Assignee: EOS of North America, Inc., Novi, MI (US)

(21) Appl. No.: 18/142,250

(22) Filed: May 2, 2023

Related U.S. Application Data
(62) Division of application No. 16/537,827, filed on Aug. 12, 2019, now abandoned.

(51) Int. Cl. H01F 41/02; H01F 1/06

(52) U.S. Cl. CPC H01F 41/0253; H01F 1/06

(57) ABSTRACT

A method of manufacturing a permanent magnet, including providing a powder composition, of which a first fraction includes ferromagnetic metal particles and a second fraction includes thermoplastic polymer particles; using the powder composition in a powder-bed based additive manufacturing process to form a part including ferromagnetic metal particles embedded in a fused thermoplastic polymer body; and subsequently conferring magnetism on the built part by arranging the finished part in a magnetic field.

### CROSS REFERENCES TO RELATED APPLICATIONS

This application is a divisional of, and claims the priority benefit of, U.S. patent application Ser. No. 16/537,827, filed Aug. 12, 2019, the contents of which are incorporated herein by reference in their entirety.

### FIELD OF THE INVENTION

The present invention relates to the field of additive manufacture (AM) using a build medium which is applied in consecutive layers and solidified at selected points or areas according to cross-sections of an object to be built, and more particularly to a medium particularly adapted to be used in making objects which will have a magnetic character, and still more particularly to manufacturing a permanent magnet; a powder composition for the method; and a permanent magnet.

### BACKGROUND

A permanent magnet is a magnet that exhibits a persistent magnetic field, and comprises a ferromagnetic material such as a ferrite, an iron alloy, or a rare earth alloy, to name a few. Large permanent magnets may be used in electrical machines such as generators, and may be manufactured by casting. Smaller permanent magnets may be used for a variety of purposes and may be formed by milling. Alternatively, the ferromagnetic metal may be provided in the form of small particles, and a mixture comprising the metal particles suspended in a fluid resin carrier can be used to mould the desired magnet shape, for example in an injection moulding process. While this approach may be more economical than conventional milling techniques, tooling of a mould is expensive, and the magnet shape is limited by the mould shape. Furthermore, the mould shape is governed by the known limitations of the injection moulding process. For these reasons, it can be quite expensive to manufacture small quantities of permanent magnets.

It has also been demonstrated that neodymium magnets can be made by fused filament fabrication. To date, however, it appears that the industry has not been able to successfully adapt the foregoing to a process using a selective laser sintering (SLS) or similar system, where a powder or other fluent material is the build medium.

Therefore, it is an object of the invention to provide a more economical way of manufacturing permanent magnets.

### SUMMARY OF THE INVENTION

Objects of the invention are achieved by the method of claim 1 of manufacturing a permanent magnet; by the powder composition of claim 7; and by the permanent magnet of claim 14.

According to the disclosure herein, the method of manufacturing a permanent magnet comprises the steps of providing a powder composition, of which a first fraction comprises ferromagnetic metal particles and a second fraction comprises thermoplastic polymer particles; using the powder composition in a powder-bed based additive manufacturing process to form a three-dimensional part comprising ferromagnetic metal particles embedded in a fused polymer body; and conferring magnetism on the finished part by treating the finished part in a magnetic field.

In the context of the invention, the term “ferromagnetic metal particles” when used in reference to the powder composition is to be understood to mean particles of metal that are not yet magnetized. In other words, the particles of metal present in the powder composition may be without magnetic properties.

During the powder-bed fusion process, for example a selective laser sintering (SLS) process, a part is built in a layer-wise manner according to a computer model (previously created using a suitable CAD program). In selective laser sintering, this is done by directing a beam of laser light at specific points in successive thin layers of the powder to melt or fuse the build material, e.g. a thermoplastic polymer, at those points. In the inventive method, the metal particles in the powder composition are not appreciably affected by the energy beam or laser, and the finished part comprises the metal particles embedded in the fused polymer body. The polymer fraction of the power composition may be referred to as the binder, while the metal fraction may be referred to as the filler. The finished part can also be referred to as a three-dimensional object or a green body.

Once the build is complete, the finished part can then be placed in a sufficiently strong magnetic field, thereby conferring magnetism on the finished part, using techniques that will be known to the skilled person. The part thus magnetised may then be referred to as a permanent magnet.

According to an aspect of the invention, the powder composition (for use in the inventive method) is essentially composed of two fractions, a first ferromagnetic metal fraction and a second thermoplastic polymer fraction, while the powder composition may also comprise small amounts of additives as will be explained below. The ferromagnetic metal fraction can comprise any of a neodymium-iron-boron alloy, a samarium-cobalt alloy, a barium ferrite, a strontium ferrite or any other suitable ferromagnetic material. The thermoplastic polymer fraction comprises any of copolyester, polyamide 6, polyamide 11, polyamide 12, polypropylene, polyphenylene sulphide, polyurethane or any other suitable thermoplastic polymer. Polyamide is also commonly referred to as nylon.

The ferromagnetic metal fraction and the thermoplastic polymer fraction are mechanically mixed or dry blended to ensure a homogenous distribution of the particles. This can be ensured by a mixing apparatus that thoroughly mixes materials of different densities. During the build process, a separation by densities may take place in a powder layer, but since the powder layer thickness is very small, such separation by density will not have a detrimental effect on the quality of the built object. A permanent magnet manufactured using the inventive method can have any shape that is achievable by additive manufacturing, especially by SLS. Because the energy beam can be controlled in a very precise manner to fuse the build material, e.g. the thermoplastic polymer, it is possible to build a part in any of a wide variety of shapes and forms. Such freedom of design is not possible with other prior art manufacturing methods such as injection moulding.

The claims and the following description disclose particularly advantageous embodiments and features of the invention. Features of the embodiments may be combined as appropriate. Features described in the context of one claim category can apply equally to another claim category.

As mentioned above, any suitable alloy may be chosen for the ferromagnetic particles of the powder composition, whereby a rare-earth alloy is most suitable since a rare-earth alloy can produce a favourably strong magnetic field. In a preferred embodiment of the invention, a neodymium-iron-boron (Nd—Fe—B) alloy doped with praseodymium (e.g. (NdPr)₂Fe₁₄B) may be used. Equally, a neodymium-iron-cobalt (Nd—Fe—Co) alloy may be used, for example an alloy comprising praseodymium and titanium (Nd—Pr—Fe—Co—Ti). Other suitable materials may be a samarium-cobalt alloy, a barium ferrite, a strontium ferrite or any other suitable ferromagnetic material. Such metals are very suitable for the manufacture of permanent magnets. When made using a powdered metallurgy process, such permanent magnets have undesirable properties such as brittleness, and a tendency to chip or crack. However, in the inventive method, these drawbacks are no longer a problem, since the metal powder is bound in the fused polymer body.

Since one objective of the present invention is to provide a straightforward way of manufacturing a permanent magnet, preferably a strong permanent magnet, the mass fraction of the ferromagnetic metal particles in the powder composition preferably comprises at least 91.5 wt %. Such a concentration will result in a strong magnetic field after the part has been magnetized. Accordingly, the thermoplastic polymer powder blend contributes a mass fraction of at most 8.5 wt % of the powder composition.

In a preferred embodiment of the invention, the ferromagnetic fraction of the powder composition and the composition of the ferromagnetic fraction are chosen to obtain a part with a remanence of at least 0.15 Tesla, more preferably at least 0.4 Tesla. For example, a 13 g part with a density of 3.5 g/cm³ after magnetization will have a remanence or flux density (Bᵣ) of 0.4 Tesla.

In a preferred embodiment of the invention, the magnetic field used to magnetize the finished part has a sufficiently high magnetic flux density in order to achieve a desired minimum remanence in the finished part. The finished part is placed in the magnetic field for a sufficient minimum duration to achieve the desired remanence. In a preferred embodiment of the invention, the thermoplastic polymer fraction comprises at least two thermoplastic polymers with different properties. Preferably, at least one thermoplastic polymer is a low viscosity (high melt flow) thermoplastic polymer. For example, a thermoplastic polymer powder blend contributing a mass fraction of 8.5 wt % of the powder composition may comprise a PA12 blend, with 1.7 wt % low viscosity PA12 and 6.8 wt % higher viscosity PA12 (referred to as the “base nylon”).

Since the ferromagnetic metal may have a greater mass than the thermoplastic polymer, the different components of the powder composition may alternatively be defined in terms of volume fraction. For example, the volume fraction of the ferromagnetic metal particles in the powder composition preferably comprises at least 0.6. Accordingly, the volume fraction of the thermoplastic polymer particles in the powder composition preferably comprises at most 0.4.

In a particularly preferred embodiment of the invention, the mean diameter of the ferromagnetic metal particles is in the range 30 μm-70 μm, whereby the particle size may depend to a large extent on the chosen alloy(s). The remanence in the final part is essentially independent of the particle size, and is instead determined by the number of individual magnetic domains in the metal alloy that will align during the magnetization procedure. The particle size can therefore be chosen to suit other process parameters, for example to facilitate a thorough mixing of the composite powder. For example, the mean diameter of the metal powder particles can be in the order of 65 microns, while the mean diameter of nylon binder powder particles can be in the order of 40-60 microns. The density of the metal powder can be in the order of 7-8 times greater than the density of the binder powder. Any ground metal alloy with powder particles having regular or irregular shapes may be used, for example a product such as MQP-S-11-9-20001.

Preferably, the method also comprises a step of applying a protective coating, for example a suitable epoxy, to the finished part to protect the exposed ferromagnetic material at the part surface from oxidation. Since the colour of the finished part is determined primarily by the colour of the ferromagnetic material, such a protective coating may also prevent discoloration of the part.

As indicated above, the powder composition can also comprise further additives, for example one or more of a nucleation agent, a flow additive, or an antioxidant. Such additives and the necessary proportions will be known to the skilled person and need not be elaborated on in the following.

Other objects and features of the present invention will become apparent from the following detailed descriptions considered in conjunction with the accompanying drawings. It is to be understood, however, that the drawings are designed solely for the purposes of illustration and not as a definition of the limits of the invention.

### BRIEF DESCRIPTION OF THE DRAWINGS

FIG. 1 illustrates a powder composition according to an embodiment of the invention;

FIG. 2 is a simplified diagram of an SLS apparatus during a build;

FIG. 3 shows a final stage in the inventive method;

FIG. 4 shows a cross-section through a permanent magnet manufactured using the inventive method.

In the drawings, like numbers refer to like elements throughout. Objects in the diagrams are not necessarily drawn to scale.

### DETAILED DESCRIPTION OF THE EMBODIMENTS

While this invention is susceptible of embodiments in many different forms, there is shown in the drawings, and will herein be described in detail, preferred embodiments of the invention with the understanding that the present disclosure is to be considered as an exemplification of the principles of the invention and is not intended to limit the broad aspect of the invention to embodiments illustrated. As used herein, the term “the invention” is not intended to limit the scope of the claimed invention and is instead a term used to discuss exemplary embodiments of the invention for explanatory purposes only.

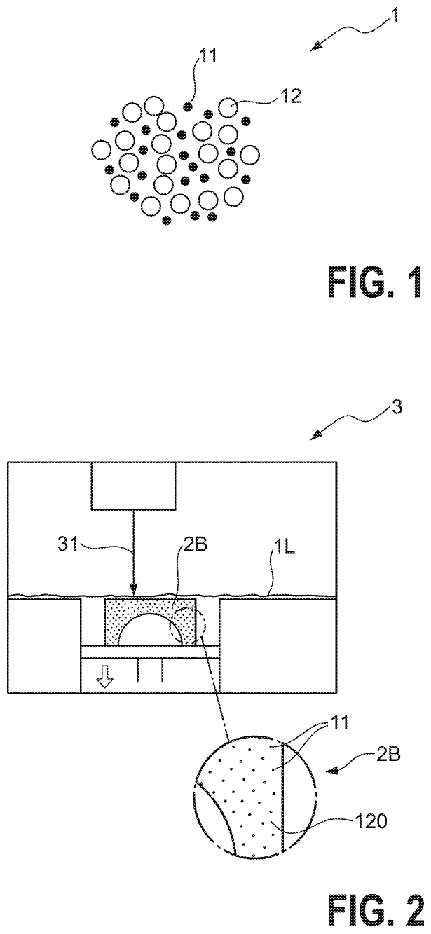

FIG. 1 illustrates a powder composition 1 according to an embodiment of the invention. The diagram shows a mixture or dry blend of ferromagnetic particles 11 and thermoplastic polymer particles 12. The powder mixture can also be obtained by melt-compounding ferromagnetic metal particles with thermoplastic polymer particles to make composite pellets, which are then ground into a size suitable for use in an SLS apparatus. In the powder mixture, the ferromagnetic particles may be assumed not to have any magnetic properties, i.e. the particles would not be attracted to a magnet in the vicinity. The ferromagnetic particles 11 may comprise one or more of the alloys or compounds mentioned above. Similarly, the thermoplastic polymer particles 12 may comprise one or more of the materials mentioned above. In this embodiment, the ferromagnetic particles 11 may be assumed to make up at least 90 wt % of the powder composition 1. The remaining 10 wt % is given by the thermoplastic polymer particles 12 and—as appropriate—small quantities of additives such as a nucleation agent, a flow additive, an antioxidant, etc. The mean diameter of the ferromagnetic particles 11 can be up to 90 μm for such an exemplary powder mixture. The ferromagnetic particles 11 and the polymer particles 12 can have any regular or irregular shape.

FIG. 2 is a simplified diagram of an SLS apparatus 3 during a build. The diagram shows a partially completed part 2B supported on a build platform 30. This can be lowered by small increments so that the upper level of the partially completed part 2B remains at essentially the same level throughout the build. The part 2B is constructed in a layer-wise manner. For each layer, the powder composition 1 (comprising a blend of ferromagnetic particles 11, thermoplastic polymer particles 12 and optional additives as described above) is spread evenly over the base 30, as will be known to the skilled person, and a laser beam 31 is then guided to fuse the thermoplastic polymer only in a set of specific points in that powder layer 1L. The heat generated by the laser beam is sufficient to melt (i.e. fuse or sinter) the polymer, but does not affect the ferromagnetic material. The part will therefore comprise metal particles 11 embedded in fused polymer 120, as shown in the enlarged portion of the diagram. When the build is complete, the finished part is allowed to cool.

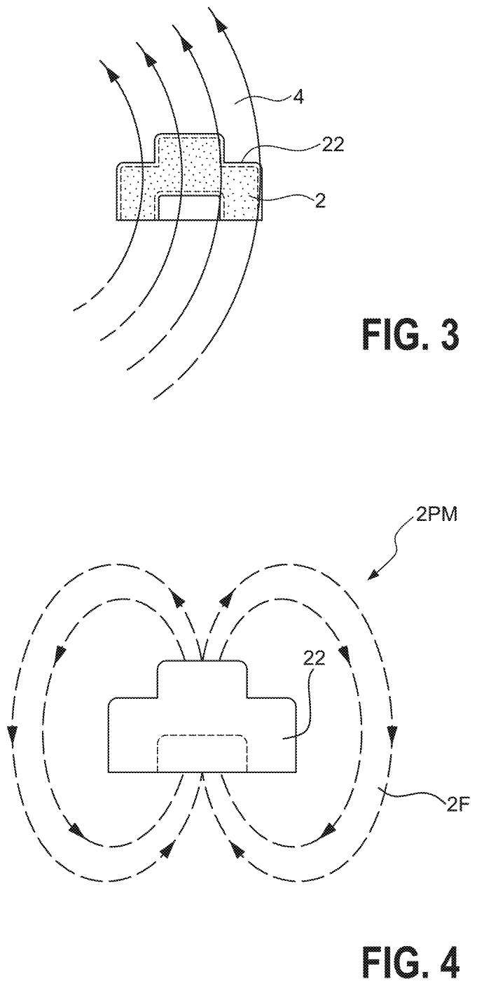

Referring to FIG. 3, in this exemplary embodiment, the finished part 2 has been formed so that it is stackable, and has been given a protective coating 22 to prevent oxidation of the ferromagnetic particles at the surface of the part 2. In this diagram, the finished part 2 is being magnetized. To this end, a sufficiently strong magnetic field 4 is generated, and the finished part 2 is placed in the field 4 for a suitable duration until the ferromagnetic particles are sufficiently saturated. This will result in magnetic properties being conferred on the finished part, i.e. the finished part will exhibit a certain remanence and will function as a permanent magnet 2PM as shown in FIG. 4.

FIG. 4 shows a cross-section through a permanent magnet 2PM manufactured using the inventive method. The diagram illustrates the persistent magnetic field 2F generated by the permanent magnet 2PM. The magnetic field 2F is the result of the magnetization process acting on the ferromagnetic metal particles 11 embedded in the fused thermoplastic polymer body 120.

The magnetic and structural properties of the finished part 2PM will depend to a large extent on the choice of powder composition and additive manufacturing process. A composite powder according to an aspect of the present invention can have a composition with up to 50% (dry weight) polymer powder and at least 50% (dry weight) ferromagnetic powder. As indicated above, the polymer powder can be chosen from one or more thermoplastic semi-crystalline polymers typically used in powder bed fusion processes such as copolyester, PA6, PA11, PA12, PP, PPS, and TPUs. Any one of these polymers, or a blend of two or more of these polymers, may be used in the composite powder to act as binder during the powder-bed fusion process.

The powder composition can comprise ferromagnetic particles in a fine powder, for example particles of a Neodymium-Iron-Boron (NdFeB) alloy, a Samarium-Cobalt (SmCo) alloy, ferrites of either Barium or Strontium, etc.

Various additives may also be included in the powder composition, for example a flow additive, an antioxidant, a nucleation agent, etc. The various fractions of the powder composition are preferably mixed to achieve a homogeneous dispersion of the ferromagnetic particles throughout the powder composition. Thorough mixing can be achieved by mechanical blending, melt compounding and subsequent grinding, chemical methods for mixing or coating the particles, etc., as will be known to the skilled person.

In one exemplary embodiment, a powder composition comprises 8.5 wt % polymer resin particles and 91.5 wt % ferromagnetic particles. To achieve a favourable melt viscosity for the magnetic composite, the polymer resin particles comprise 6.8 wt % of a high molecular weight Polyamide 12 and 1.7 wt % of a low-viscosity, high melt flow Polyamide 12. The ferromagnetic particles comprise Neodymium-Iron-Boron (NdFeB) alloy powder. The powder components were mechanically mixed for 30 minutes. The powder composition thus provided is then suitable for use in a commercial SLS machine.

In another exemplary embodiment, the powder composition may comprise ground neodymium alloy particles, for example a product such as MQP-AA4-15-7, i.e. Nd—Pr—Fe—B alloy particles with a mean diameter of 65 microns. Alternatively or in addition, the powder composition may comprise a product such asMQP-S-11 9, i.e. spherical particles of a Nd—Pr—Fe—Co—Ti—B alloy with a mean diameter of 43 microns.

A favourable formula for the inventive powder composition may comprise 91.5 wt % (or a volume fraction of 60%) neodymium alloy, 6.8 wt % PA12 and 1.7 wt % low viscosity, high melt flow PA12. These components are then dry-blended to obtain the powder composition for use in a laser sintering process, for example a powder bed fusion process. In a powder bed fusion process, as described above, layers of powder material are successively laid down in a build area, with a laser or some other type of electromagnetic or solidification energy being applied to each layer in a controlled manner according to the layer cross section of the object being built.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method of manufacturing a permanent magnet, comprising:
providing a powder composition, of which a first fraction comprises ferromagnetic metal particles and a second fraction comprises thermoplastic polymer particles;
using the powder composition in a powder-bed based additive manufacturing process to form a part comprising ferromagnetic metal particles embedded in a fused thermoplastic polymer body, the part being formed by applying the powder composition layer on layer corresponding to cross sections of the part and selectively solidifying the powder composition by application of laser radiation to fuse the powder at positions in each layer which correspond to the cross-section of the part in the layer; and
conferring magnetism on the part by arranging the finished part in a magnetic field,
wherein the first fraction is about 91.5% weight magnetic particles and the second fraction is about 8.5% weight polymer resin, wherein the polymer resin is a physical blend of about 6.8% weight polyamide 12 and about 1.7% weight of a low viscosity polyamide 12, and the magnetic particles comprise fine ground alloy powder including Neodymium-Iron-Boron powder, the fractions being mechanically mixed for the composite.

2. The method of claim 1, wherein the ground alloy is Nd—Pr—Fe—B alloy with a d50=65 microns.

3. The method of claim 1, wherein the ground allow is spherical particles of Nd—Pr—Fe—Co—Ti—B alloy with a d50=43 microns.
